(19) United States
(12) Patent Application Publication
(10) Pub. No.: US 2014/0095984 A1
(43) Pub. Date: Apr. 3, 2014

(54) INFORMATION PROCESSING DEVICE, METHOD AND PROGRAM RECORDING MEDIUM

(71) Applicant: NEC Corporation, Tokyo (JP)

(72) Inventor: Hiroyuki KOBAYASHI, Tokyo (JP)

(73) Assignee: NEC Corporation, Tokyo (JP)

(21) Appl. No.: 14/038,931

(22) Filed: Sep. 27, 2013

(30) Foreign Application Priority Data
Sep. 28, 2012 (JP) 2012-215354

(51) Int. Cl. G06F 17/22

(52) U.S. Cl. CPC G06F 17/227
USPC 715/239

(57) ABSTRACT

An information processing device includes: an external file replacement unit which detects, from structured data displayed on a screen, an external file name of an external file which the structured data quotes, and replaces the external file name by a file name of a file having smaller volume of data than the external file; a structured data conversion unit which converts the structured data and the file, which is quoted by the structured data and has smaller volume of data than the external file, into intermediate data having a different data format from the structured data; and an intermediate data conversion unit which converts the intermediate data into data after conversion having a different data format from the structured data and the intermediate data, detects the file name of the file from the data after conversion, and restores the file name to the external file name.

This application is based upon and claims the benefit of priority from Japanese Patent Application No. 2012-215354, filed on Sep. 28, 2012, the disclosure of which is incorporated herein in its entirety by reference.

### TECHNICAL FIELD

The present invention relates to an information processing device, a method and a program recording medium.

### BACKGROUND ART

In Japanese Unexamined Patent Application Publication No. 2009-122933, a technology is disclosed which is related to conversion of structured document data (XML document) to data with a different format. In the technology, correspondence of data elements before and after the data conversion, is created by using a method for creating a data conversion definition, and thus, even in case a data structure of conversion source or conversion destination is changed, it makes possible to conduct the data conversion possible.

In Japanese Unexamined Patent Application Publication No. 2004-118522, a data processing device is disclosed which extracts data which shows characteristics of image data as an external file, and stores the external file as different information of the image data.

In Japanese Unexamined Patent Application Publication No. 2009-159379, an information processing device is disclosed which, when image data and text data are synthesized, creates data after conversion in accordance with each data format.

### SUMMARY

An example of object of the present invention is to realize speedup of data conversion of structured data.

An information processing device according to an exemplary aspect of the present invention includes: an external file replacement unit which detects, from structured data displayed on a screen, an external file name of an external file which the structured data quotes, and replaces the external file name by a file name of a file having smaller volume of data than the external file; a structured data conversion unit which converts the structured data and the file, which is quoted by the structured data and has smaller volume of data than the external file, into intermediate data having a different data format from the structured data; and an intermediate data conversion unit which converts the intermediate data into data after conversion having a different data format from the structured data and the intermediate data, detects, from the data after conversion, the file name of the file which is quoted by the data after conversion and has smaller volume of data than the external file, and restores the file name to the external file name.

A method according to an exemplary aspect of the present invention includes: detecting, from structured data displayed on a screen, an external file name of an external file which the structured data quotes; replacing the external file name by a file name of a file having smaller volume of data than said external file; converting the structured data and the file, which is quoted by the structured data and has smaller volume of data than the external file, into intermediate data having a different data format from the structured data; converting the intermediate data into data after conversion having a different data format from the structured data and the intermediate data; detecting, from the data after conversion, the file name of the file which is quoted by the data after conversion and has smaller volume of data than the external file; and restoring the file name to the external file name.

A program recording medium according to an exemplary aspect of the present invention records a program which makes a computer execute: processing for detecting, from structured data displayed on a screen, an external file name of an external file which the structured data quotes, and replacing the external file name by a file name of a file having smaller volume of data than said external file; processing for converting the structured data and the file, which is quoted by the structured data and has smaller volume of data than the external file, into intermediate data having a different data format from the structured data; and processing for converting the intermediate data into data after conversion having a different data format from the structured data and the intermediate data, detecting, from said data after conversion, the file name of the file which is quoted by the data after conversion and has smaller volume of data than the external file, and restoring the file name to the external file name.

### BRIEF DESCRIPTION OF THE DRAWINGS

Exemplary features and advantages of the present invention will become apparent from the following detailed description when taken with the accompanying drawings in which:

FIG. 1 is a figure showing an example of a structure of a data format conversion device according to the first exemplary embodiment of the present invention.

FIG. 2 is a figure showing an example of operation of the data format conversion device.

FIG. 3 is a flow chart showing processing which replaces an external file which structured data quotes.

FIG. 4 is a flow chart showing data conversion processing from intermediate data to data after conversion.

FIG. 5 is a figure showing an example of a structure of a data format conversion device according to the second exemplary embodiment.

FIG. 6 is a figure showing an example of a structure of a data format conversion device according to the third exemplary embodiment.

### EXEMPLARY EMBODIMENT

### The First Exemplary Embodiment

The first embodiment for carrying out the invention will be described in detail with reference to drawings.

In a technology for data conversion, there is a case when an information processing device converts structured document data (hereinafter, structured data) of data format such as an OOXML (Office Open XML) directly into data (hereinafter, data after conversion) of other data format such as an HTML (HyperText Markup Language). In this technology, there is a case when reproducing and displaying a drawing image of the structured data by a specific application (hereinafter, application for drawing editing) such as Microsoft Office (registered trademark) using the data after conversion may be difficult. This is because drawing logic of the application for drawing editing is unclear.

On the other hand, there is a case when the application for drawing editing may have a function for converting structured data into data having a different data format from the structured data (hereinafter, intermediate data) of data format such as an XPS (XML Paper Specification). In the present invention, a technique is used in which the application for drawing editing including such function converts the structured data into the intermediate data and further converts the intermediate data into the data after conversion. By using such a technique, there is a case when the drawing image becomes easy to reproduce.

Further, a data format conversion device 10 according to the first exemplary embodiment of the present invention realizes speedup of data conversion of the structured data aiming at the case when the technique mentioned above is used.

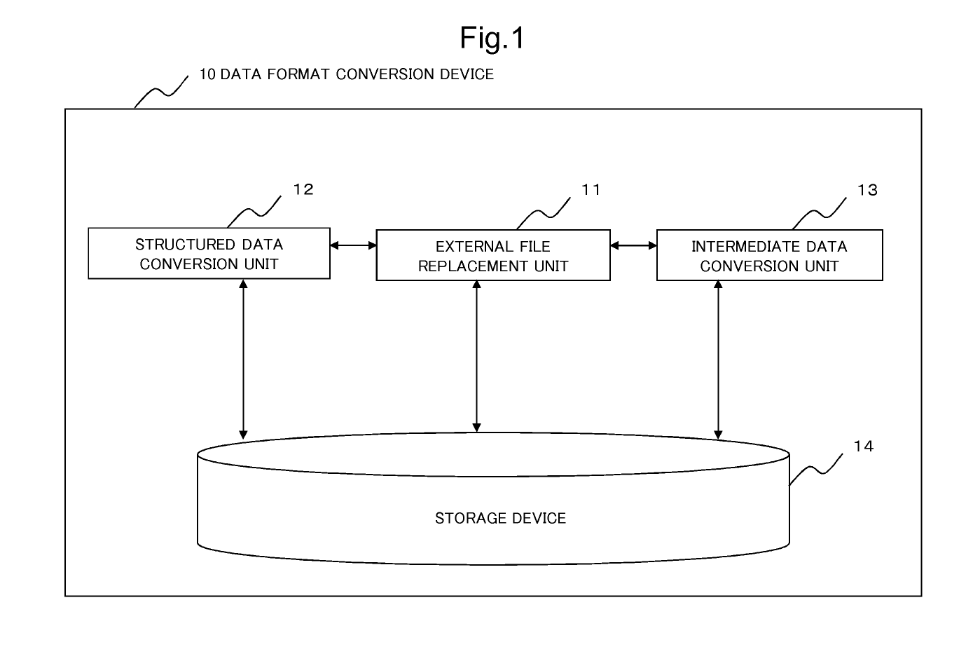

FIG. 1 is a figure showing an example of a structure of the data format conversion device 10. The data format conversion device 10 includes an external file replacement unit 11, a structured data conversion unit 12, an intermediate data conversion unit 13 and a storage device 14.

The external file replacement unit 11 acquires structured data displayed on a screen from the storage device 14 and detects from the structured data, a name of an external file (external file name) quoted such as an image file. And, the external file replacement unit 11 replaces the external file name by a file name (hereinafter, replacement file name) of a file (hereinafter, replacement file) having smaller volume of data than the original file (external file) and stores it in the storage device 14.

Further, the structured data further includes information which shows a position where the external file quoted is displayed on the screen and its shape.

Also, the external file replacement unit 11 issues a conversion command of data format from the structured data to the intermediate data for the structured data conversion unit 12.

Further, the external file replacement unit 11 creates quotation file replacement information which shows corresponding relationship between the external file and the replacement file and stores it in the storage device 14. Also, the external file replacement unit 11 notifies the intermediate data conversion unit 13 that the quotation file replacement information of the external file and the replacement file is created.

The structured data conversion unit 12 receives the conversion command from the external file replacement unit 11, and acquires the structured data which is outputted from the external file replacement unit 11 and is stored in the storage device 14. And, the structured data conversion unit 12 converts the structured data and the replacement file which the structured data quotes into the intermediate data having a different data format from the structured data and stores the converted intermediate data in the storage device 14.

Further, by the structured data conversion unit 12, conversion to the intermediate data is performed without changing the position where the external file is displayed on the screen and the shape of the external file.

The intermediate data conversion unit 13 acquires the intermediate data which the structured data conversion unit 12 created from the storage device 14 and converts the acquired intermediate data into the data after conversion having a different data format from the structured data and the intermediate data.

Further the intermediate data conversion unit 13 detects the quoted replacement file name from the data after conversion, acquires the quotation file replacement information from the storage device 14, and restores the replacement file name in the data after conversion to one of the original file (that is, external file name). And, it stores the data after conversion in the storage device 14.

Further, by the intermediate data conversion unit 13, conversion to the data after conversion is performed without changing the position where the external file is displayed on the screen and the shape of the external file.

Here, the external file replacement unit 11, the structured data conversion unit 12 and the intermediate data conversion unit 13 are structured by hardware such as a logic circuit.

Also, the storage device 14 is a storage device such as a disk device and a semiconductor memory.

Also, the external file replacement unit 11, the structured data conversion unit 12 and the intermediate data conversion unit 13 may be realized by a processor of the data format conversion device 10 which is a computer executing a program on a memory which is not illustrated.

Further, the structured data conversion unit 12 may be realized by the application for drawing editing such as Microsoft Office (registered trademark) mentioned above.

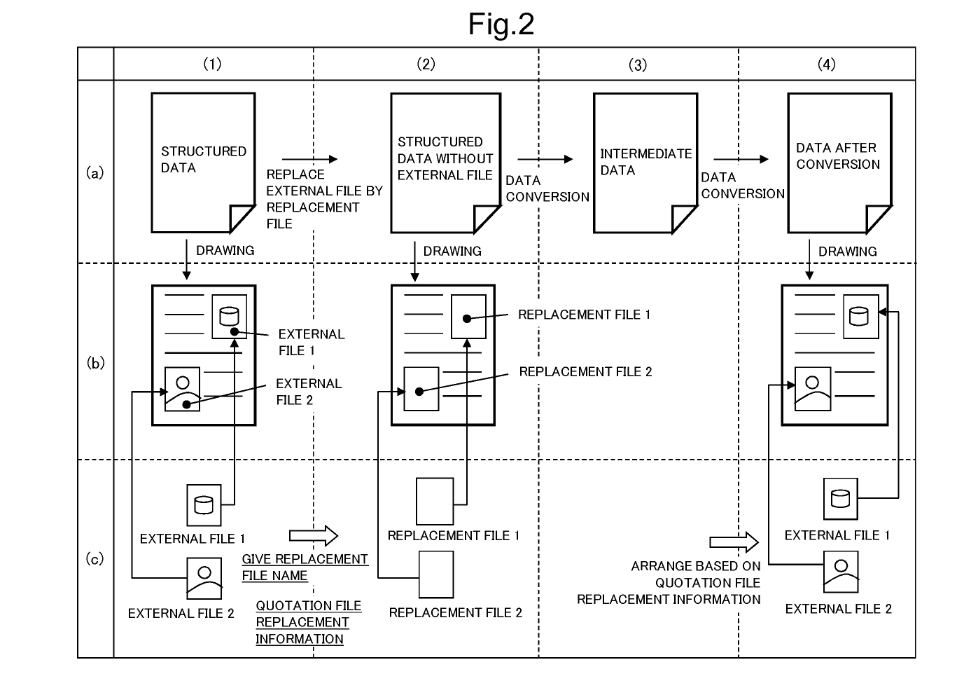

FIG. 2 is a figure showing an example of data conversion process which the data format conversion device 10 performs.

Column (1) row (a) shows an initial state of structured data. A figure of column (1) row (b) is a figure showing a state which the application for drawing editing displayed the structured data and external files which the structured data quotes. Also, as shown in a figure of column (1) row (c), the external file is set, for example, as two kinds of an external file 1 and an external file 2.

Column (2) row (a) shows a state of the structured data before the structured data conversion unit 12 converts the structured data into intermediate data. A figure of column (2) row (b) is a figure showing a state which the external file replacement unit 11 replaced the structured data by replacement files without changing the display position of the external files quoted by the structured data on the screen and the shape of the external files.

Also, as shown in a figure of column (2) row (c), the external file replacement unit 11 gives a replacement file name to each replacement file and creates quotation file replacement information which shows a corresponding relationship between the external files and the replacement files.

Next, as shown in a figure of column (3) row (a), the structured data conversion unit 12 converts the structured data in which the external file name is replaced by the replacement file name into the intermediate data.

Further, column (4) row (a) shows a state which a data format is converted from the intermediate data into data after conversion. In that case, by restoring them to each original external file without changing the position and the shape of each replacement file replaced at column (2) row (b), as shown in column (4) row (b), the drawing image displayed by the application for drawing editing at column (1) row (b) is reproduced.

Further, here, as shown at column (4) row (c), the original external file is selected based on the quotation file replacement information created at column (2) row (c).

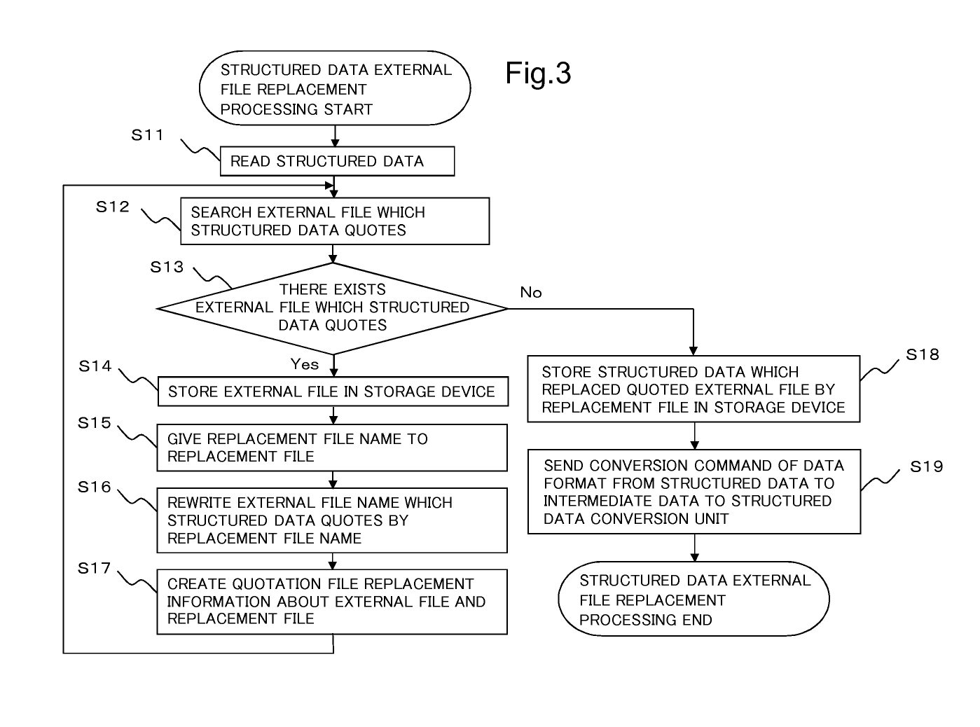

FIG. 3 is a flow chart showing processing which replaces an external file which structured data quotes.

First, the external file replacement unit 11 acquires the structured data from the storage device 14 (S11).

Next, the external file replacement unit 11 performs a search if the structured data quotes an external file (S12), and determines whether there exists the external file which the structured data quotes (S13).

In case of Yes in (S13), the external file replacement unit 11 stores the external file in the storage device 14 (S14).

Also, the external file replacement unit 11 gives a replacement file name to a replacement file (S15). The external file replacement unit 11 rewrites the external file name which the structured data quotes by the replacement file name of the replacement file (S16).

Further, the external file replacement unit 11 creates quotation file replacement information which shows a corresponding relationship between the external file and the replacement file and stores it in the storage device 14 (S17).

After this, the external file replacement unit 11 repeats the search of the following external files (S12-S17).

On the other hand, when replacement from the external file to the replacement file is completed (in case of No in (S13)), the external file replacement unit 11 stores the structured data which replaced the quoted external file by the replacement file in the storage device 14 (S18).

Also, the external file replacement unit 11 sends to the structured data conversion unit 12 a conversion command of data format from the structured data to the intermediate data (S19).

Further, after this, the structured data conversion unit 12, by receiving the conversion command of data format, converts the structured data into the intermediate data and stores it in the storage device 14. This conversion may be performed, for example, by Microsoft Office (registered trademark).

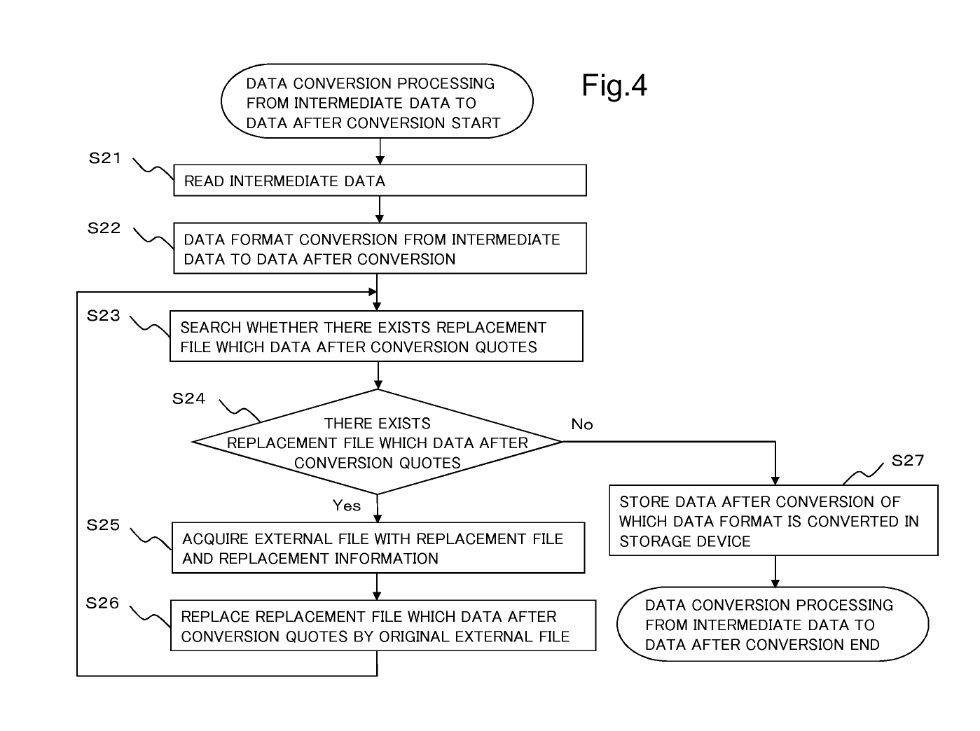

FIG. 4 is a flow chart showing data conversion processing from intermediate data to data after conversion.

First, the intermediate data conversion unit 13 acquires the intermediate data from the storage device 14 (S21) and performs conversion of data format from the intermediate data to the data after conversion (S22).

Next, the intermediate data conversion unit 13 performs a search if there exits a replacement file which the data after conversion quotes (S23), and determines whether there exists the replacement file which the data after conversion quotes (S24).

In case there exists the replacement file which the data after conversion quotes (Yes in S24), the intermediate data conversion unit 13 acquires the external file for which the corresponding relationship with the replacement file which the data after conversion quotes is shown in the quotation file replacement information from the storage device 14 (S25), and rewrites the replacement file name which the data after conversion includes by the original external file name (S26).

After this, the intermediate data conversion unit 13 repeats the search of the following replacement files (S23-S26).

On the other hand, when replacement of the replacement file to the original external file is completed (in case of No in S24), the intermediate data conversion unit 13 stores the data after conversion in which the data format is converted in the storage device 14 (S27).

The data format conversion device 10 according to this exemplary embodiment takes effect described in the following.

When the structured data is converted into data of other data format, speedup of conversion processing is realized. The reason is because structured data displayed on a screen is acquired, an external file name of a quoted external file is detected from the structured data, and the external file name is replaced by a file name of a file having smaller volume of data than the original external file.

### The Second Exemplary Embodiment

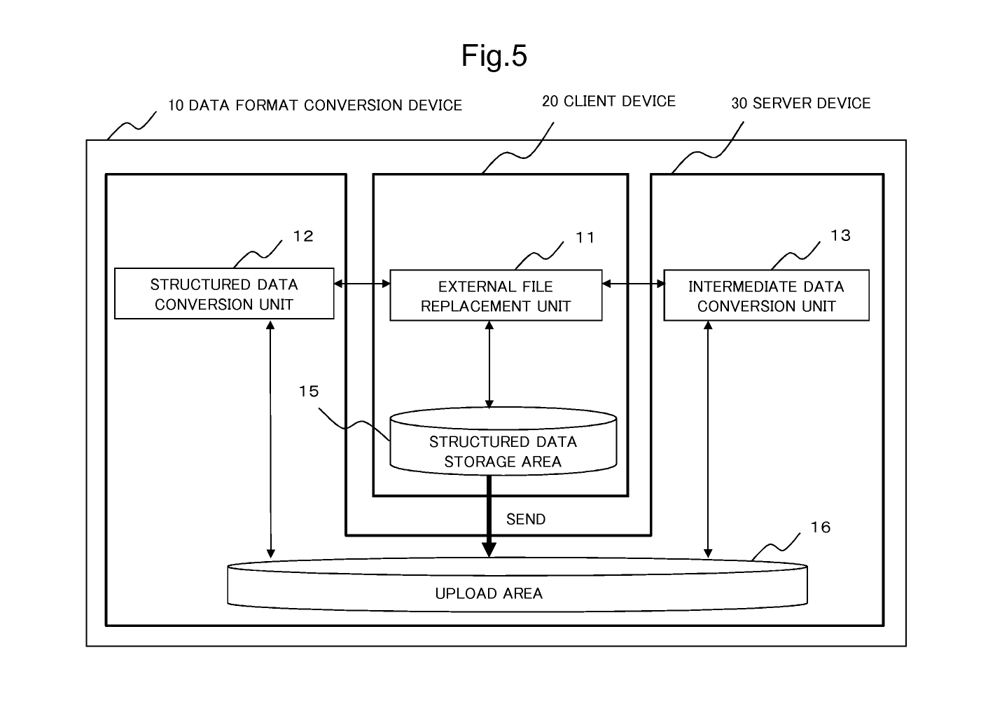

FIG. 5 is a figure showing an example of a structure of the data format conversion device 10 according to the second exemplary embodiment.

The data format conversion device 10 according to this exemplary embodiment assigns functions of the data format conversion device 10 according the structure of the first exemplary embodiment to a client device 20 and a server device 30.

Also, the storage device 14 is replaced by a structured data storage area 15 in the client device 20 and by an upload area 16 in the server device 30 respectively.

The client device 20 includes the external file replacement unit 11 and the structured data storage area 15.

The structured data storage area 15 stores structured data, an external file, a replacement file and quotation file replacement information.

The server device 30 includes the structured data conversion unit 12, the intermediate data conversion unit 13 and the upload area 16.

Also, by a file transfer unit of the client device 20 which is not illustrated by sending information in the structured data storage area 15 to the server device 30, the upload area 16 can acquire (upload) the information in the structured data storage area 15. Also, the upload area 16 stores intermediate data and data after conversion.

Here, the structured data storage area 15 and the upload area 16 are a storage device such as a disk device and a semiconductor memory.

The data format conversion device 10 according to this exemplary embodiment uploads the structured data in the client device 20 (structured data storage area 15) to the server device 30 (upload area 16) and performs conversion of data format (from the structured data to the intermediate data and from the intermediate data to the data after conversion) in the server device 30. Operation of the external file replacement unit 11, the structured data conversion unit 12 and the intermediate data conversion unit 13 is same as the first exemplary embodiment.

Further, by using the data format conversion device 10 according to this exemplary embodiment, for example, such as a web conference system which converts structured data (document) possessed by a client side into data of an HTML format on a server side and shares the data among web participants; and a documentation management system which converts structured data (document) possessed by a client side into data of an HTML format on a server side and performs thumbnail display of the document; may be built.

The data format conversion device 10 according to this exemplary embodiment takes effect described in the following.

Speedup of conversion processing of data format is possible. The reason is because the server device 30 with higher processing power compared with the client device 20 is used for conversion processing of data format.

### The Third Exemplary Embodiment

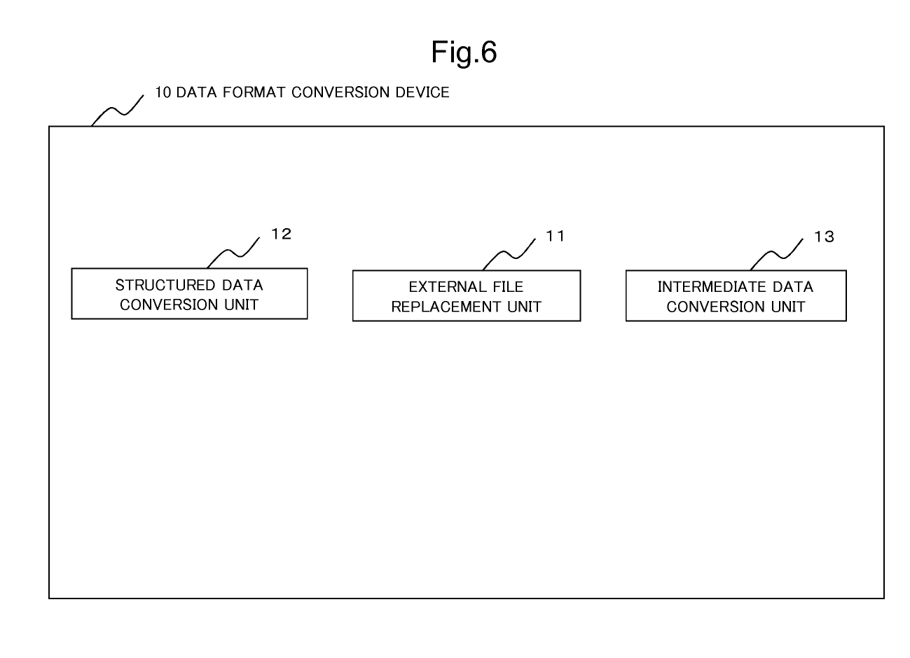

FIG. 6 is a figure showing an example of a structure of the data format conversion device 10 according to the third exemplary embodiment.

The data format conversion device 10 includes the external file replacement unit 11, the structured data conversion unit 12 and the intermediate data conversion unit 13.

The external file replacement unit 11 acquires structured data displayed on a screen, detects, from the structured data, an external file name of an external file which the structured data quotes, and replaces the external file name by a file name of a file having smaller volume of data than the external file.

The structured data conversion unit 12 acquires the structured data which the external file replacement unit 11 outputted, and converts the structured data and the file which is quoted by the structured data and has smaller volume of data than the external file into intermediate data having a different data format from the structured data.

The intermediate data conversion unit 13 acquires the intermediate data, convert the intermediate data into data after conversion having a different data format from the structured data and the intermediate data, detects, from the data after conversion, the file name of the file which is quoted by the data after conversion and has smaller volume of data than the external file, and restores the file name to the original external file name.

Here, the external file replacement unit 11, the structured data conversion unit 12 and the intermediate data conversion unit 13 are structured by hardware such as a logic circuit.

Also, the external file replacement unit 11, the structured data conversion unit 12 and the intermediate data conversion unit 13 may be realized by a processor of the data format conversion device 10 which is a computer executing a program on a memory which is not illustrated.

The data format conversion device 10 according to this exemplary embodiment takes effect described in the following.

When structured data is converted into data of other data format, speedup of conversion processing is realized. The reason is because structured data displayed on a screen is acquired, an external file name of a quoted external file is detected from the structured data, and the external file name is replaced by a file name of a file having smaller volume of data than the original external file.

Further, in case the technology described in the related document mentioned above is used, there was a problem that, when structured document data in which an external file such as an image file is quoted is converted into data of a different data format, conversion processing takes time.

An exemplary advantage according to the present invention is, even in case an existing product is used which replaces data in an external file when structured document data is converted into data of other data format, speedup of conversion processing can be realized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is noted that the inventor's intent is to retain all equivalents of the claimed invention even if the claims are amended during prosecution.

1. An information processing device comprising:
an external file replacement unit which detects, from structured data displayed on a screen, an external file name of an external file which the structured data quotes, and replaces the external file name by a file name of a file having smaller volume of data than said external file;
a structured data conversion unit which converts said structured data and the file, which is quoted by the structured data and has smaller volume of data than said external file, into intermediate data having a different data format from said structured data; and
an intermediate data conversion unit which converts said intermediate data into data after conversion having a different data format from said structured data and said intermediate data, detects, from said data after conversion, the file name of the file which is quoted by said data after conversion and has smaller volume of data than said external file, and restores the file name to the external file name.

2. The information processing device according to claim 1, wherein said structured data comprises information which shows a position where said external file which the structured data quotes is displayed on said screen and a shape of the external file,
said structured data conversion unit converts said structured data and said file into the intermediate data without changing the position where said external file is displayed on said screen and the shape of the external file, and
said intermediate data unit converts said intermediate data into the data after conversion without changing the position where said external file is displayed on said screen and the shape of the external file.

3. The information processing device according to claim 1, wherein said structured data is in an OOXML format; said intermediate data is in an XPS format, and said data after conversion is in an HTML format.

4. The information processing device according to claim 1 further comprising a storage device which stores at least either one of said structured data, said external file, said intermediate data and said data after conversion.

5. A method comprising: detecting, from structured data displayed on a screen, an external file name of an external file which the structured data quotes; replacing the external file name by a file name of a file having smaller volume of data than said external file;
converting said structured data and the file, which is quoted by the structured data and has smaller volume of data than said external file, into intermediate data having a different data format from said structured data;
converting said intermediate data into data after conversion having a different data format from said structured data and said intermediate data; detecting, from said data after conversion, the file name of the file which is quoted by the data after conversion and has smaller volume of data than said external file; and restoring the file name to the external file name.

6. The method according to claim 5, wherein said structured data comprises information which shows a position where said external file which the structured data quotes is displayed on said screen and a shape of the external file,
by said method, conversion to the intermediate data is performed without changing the position where said external file is displayed on said screen and the shape of the external file and conversion to the data after conversion is performed without changing the position where said external file is displayed on said screen and the shape of the external file.

7. The method according to claim 5, wherein said structured data is in an OOXML format, said intermediate data is in an XPS format, and said data after conversion is in an HTML format.

8. A program recording medium for recording a program which makes a computer execute: processing for detecting, from structured data displayed on a screen, an external file name of an external file which the structured data quotes, and replacing the external file name by a file name of a file having smaller volume of data than said external file;
processing for converting said structured data and the file, which is quoted by the structured data and has smaller volume of data than said external file, into intermediate data having a different data format from said structured data; and
processing for converting said intermediate data into data after conversion having a different data format from said structured data and said intermediate data, detecting, from said data after conversion, the file name of the file which is quoted by the data after conversion and has smaller volume of data than said external file, and restoring the file name to the external file name.

9. The program recording medium according to claim 8, wherein said structured data comprises information which shows a position where said external file which the structured data quotes is displayed on said screen and a shape of the external file; and
for recording a program which makes said computer execute: processing by which conversion to the intermediate data is performed without changing the position where said external file is displayed on said screen and the shape of the external file; and
processing by which conversion to the data after conversion is performed without changing the position where said external file is displayed on said screen and the shape of the external file.

10. The program recording medium according to claim 8, wherein said structured data is in an OOXML format, said intermediate data is in an XPS format, and said data after conversion is in an HTML format.
